(19) United States
(12) Patent Application Publication
(10) Pub. No.: US 2026/0255253 A1
(43) Pub. Date: Aug. 27, 2026

(54) METHODS FOR SUPPORTING USER EQUIPMENT AGGREGATION WITH NON-3GPP CONNECTION IN MOBILE COMMUNICATIONS

(71) Applicant: MEDIATEK INC., Hsinchu City (TW)

(72) Inventors: Guan-Yu LIN, Hsinchu City (TW); Ming-Yuan CHENG, Hsinchu City (TW)

(21) Appl. No.: 19/160,216

(22) PCT Filed: Mar. 13, 2024
(86) PCT No.: PCT/CN2024/081408

§ 371 Date: Aug. 27, 2025

Related U.S. Application Data
(60) Provisional application No. 63/492,255, filed on Mar. 27, 2023.

(51) Int. Cl. H04W 40/22; H04W 88/04

(52) U.S. Cl. CPC H04W 40/22; H04W 88/04

(57) ABSTRACT

Various solutions for supporting user equipment (UE) aggregation with non-3^{rd} generation partnership project (3GPP) connection in mobile communications are described. A remote UE may connect to a relay UE using a non-3GPP connection. The remote UE may receive a radio resource control (RRC) message from a network node of a wireless network. The RRC message may include a configuration of a non-3GPP connection (N3C) indirect path between the remote UE and the network node through the relay UE. The remote UE may perform one or more first data transmissions or receptions on the N3C indirect path according to the configuration. The first data transmissions or receptions on the N3C indirect path are performed with an association between a first protocol entity in the remote UE and a second protocol entity in the relay UE over the non-3GPP connection.

### CROSS REFERENCE TO RELATED PATENT APPLICATION(S)

The present disclosure is part of a non-provisional application claiming the priority benefit of U.S. Patent Application No. 63/492,255, filed 27 Mar. 2023, the content of which herein being incorporated by reference in its entirety.

### TECHNICAL FIELD

The present disclosure is generally related to mobile communications and, more particularly, to supporting user equipment (UE) aggregation with non-3^{rd} generation partnership project (3GPP) connection in mobile communications.

### BACKGROUND

Unless otherwise indicated herein, approaches described in this section are not prior art to the claims listed below and are not admitted as prior art by inclusion in this section.

Cellular based vehicle-to-everything (V2X) (e.g., long-term evolution (LTE) V2X or new radio (NR) V2X) is a radio access technology developed by 3GPP to support advanced vehicular applications. In V2X, a direct radio link (also called a sidelink) may be established between two UEs (e.g., mounted on vehicles). The sidelink may operate under the control of a cellular network (e.g., for radio resource allocation) when the UEs are within the coverage of the cellular network. Alternatively, the sidelink may operate independently, e.g., when no cellular network is present or reachable. Until 3GPP Release 17, UE-to-network relay is still a single-path relay solution in which a remote UE is connected to network either directly or indirectly via a relay UE.

In 3GPP Release 18, support of multi-path relay solution is introduced, where a remote UE may be connected to network on a direct path and an indirect path using sidelink, to improve the reliability/robustness as well as throughput. This multi-path relay solution may also be applied for UE aggregation where a remote UE may be connected to network on a direct path using 3GPP radio interface and on an indirect path via a relay UE using a non-3GPP connection (i.e., a connection using non-3GPP technology, such as wireless fidelity (Wi-Fi) or bluetooth (BT)). However, the details of supporting UE aggregation with non-3GPP connection have not been fully discussed yet. For example, the protocol stack design for the UE-to-UE interface is undefined, which would cause impacts on several aspects, including failure detection and/or retransmission mechanism of the UE-to-UE link, and the way of radio bearer (RB) identity (ID) transmission along the UE-to-UE link.

Therefore, there is a need to provide solutions for the aforementioned issues in supporting UE aggregation with non-3GPP connection.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to supporting UE aggregation with non-3GPP connection in mobile communications.

In one aspect, a method may involve a remote UE connecting to a relay UE using a non-3GPP connection. The method may also involve the remote UE receiving a radio resource control (RRC) message from a network node of a wireless network. The RRC message may include a configuration of a non-3GPP connection (N3C) indirect path between the remote UE and the network node through the relay UE. The method may further involve the remote UE performing one or more first data transmissions or receptions on the N3C indirect path according to the configuration. The first data transmissions or receptions on the N3C indirect path are performed with an association between a first protocol entity in the remote UE and a second protocol entity in the relay UE over the non-3GPP connection.

In one aspect, a method may involve a relay UE connecting with a remote UE using a non-3GPP connection. The method may also involve the relay UE receiving an RRC message from a network node of a wireless network. The RRC message may include a configuration of an N3C indirect path between the remote UE and the network node through the relay UE. The method may further involve the relay UE forwarding data traffic on the N3C indirect path according to the configuration. The forwarding of the data traffic on the N3C indirect path is performed with an association between a first protocol entity in the remote UE and a second protocol entity in the relay UE over the non-3GPP connection.

In one aspect, a method may involve a network node transmitting an RRC message to a remote UE and a relay UE. The RRC message may include a configuration of an N3C indirect path between the remote UE and the network node through the relay UE. The method may also involve the network node performing one or more first data transmissions or receptions on the N3C indirect path according to the configuration. The first data transmissions or receptions on the N3C indirect path are performed with an association between a first protocol entity in the remote UE and a second protocol entity in the relay UE over the non-3GPP connection.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), beyond 5G (B5G), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of UE aggregation with non-3GPP connection under schemes in accordance with implementations of the present disclosure.

FIG. 2 illustrates an example scenario of protocol stack mapping for MP relay using N3C indirect path in accordance with an implementation of the present disclosure.

FIG. 3 illustrates an example scenario of protocol stack mapping for MP relay using N3C indirect path in accordance with an implementation of the present disclosure.

FIG. 4 illustrates an example scenario of protocol stack mapping for MP relay using N3C indirect path in accordance with an implementation of the present disclosure.

FIG. 5 illustrates an example scenario of protocol stack mapping for MP relay using N3C indirect path in accordance with an implementation of the present disclosure.

FIG. 6 illustrates an example scenario of protocol stack mapping for MP relay using N3C indirect path in accordance with an implementation of the present disclosure.

FIG. 7 illustrates an example scenario of protocol stack mapping for MP relay using N3C indirect path in accordance with an implementation of the present disclosure.

FIG. 8 is a block diagram of an example communication system in accordance with an implementation of the present disclosure.

FIG. 9 is a flowchart of an example process in accordance with an implementation of the present disclosure.

FIG. 10 is a flowchart of an example process in accordance with an implementation of the present disclosure.

FIG. 11 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to supporting UE aggregation with non-3GPP connection in mobile communications. According to the present disclosure, a number of possible solutions may be implemented separately or jointly. That is, although these possible solutions may be described below separately, two or more of these possible solutions may be implemented in one combination or another.

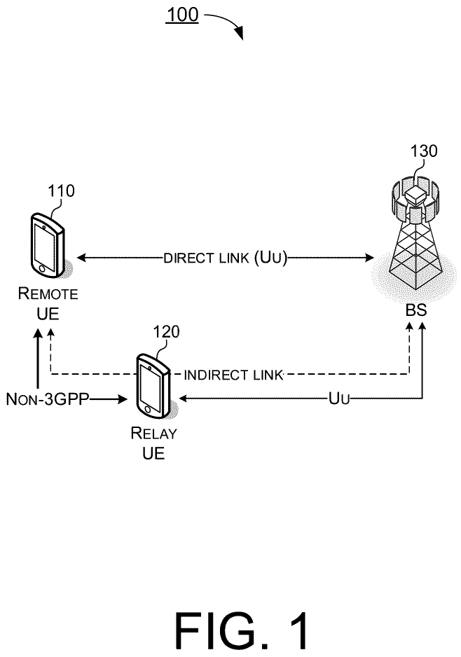

FIG. 1 illustrates an example scenario 100 of UE aggregation with non-3GPP connection under schemes in accordance with implementations of the present disclosure. Scenario 100 involves a remote UE 110 (or called a primary UE), a relay UE 120 (or called an assisting UE), and a base station (BS) 130 (e.g., an evolved Node-B (eNB), a Next Generation Node-B (gNB), or a transmission/reception point (TRP)) which may be a part of a wireless network (e.g., an LTE network, a 5G NR network, an IoT network or a 6G network). The remote UE 110 is configured with multi-path (MP), including one direct link and one indirect link. Specifically, the remote UE 110 connects to network on the direct path using (NR) Uu interface, and connects to network on the indirect path via the relay UE 120, wherein the UE-to-UE link is realized with a non-3GPP connection (e.g., a Wi-Fi or BT connection). On the indirect path, for the hop between the remote UE 110 and the relay UE 120, when the remote UE 110 connects to the relay UE 120 via a non-3GPP connection, the network may provide the configuration of N3C indirect path to the remote UE 110 and the relay UE 120 via RRC signaling (e.g., an RRC Reconfiguration message). Accordingly, the remote UE 110 and the BS 130 may perform data transmission(s) or reception(s) on the N3C indirect path according to the configuration, and the relay UE 120 may forward data traffic (e.g., between the remote UE 120 and the BS 130) on the N3C indirect path according to the configuration. More specifically, the data transmission(s)/reception(s) or data traffic forwarding on the N3C indirect path is/are performed with certain protocol stack mapping that can be represented by an association between two protocol entities in the remote UE and the relay UE over the non-3GPP connection.

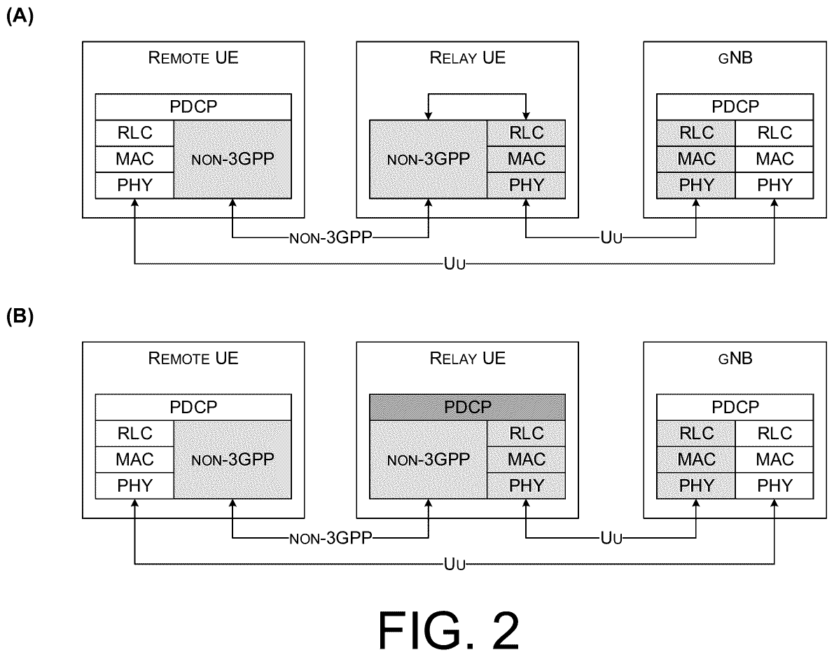

FIGS. 2-7 illustrate example scenarios of protocol stack mapping for MP relay using N3C indirect path under various schemes in accordance with implementations of the present disclosure.

Referring to FIG. 2, Part (A) depicts a protocol stack mapping for MP relay using N3C indirect path, where the UE-to-UE link is provided with an association between the Uu packet data convergence protocol (PDCP) entity in the remote UE and the Uu radio link control (RLC) entity in the relay UE over a non-3GPP connection. The network (e.g., a gNB) may configure the relay UE with mapping(s) between the Uu RB ID(s) of the remote UE and the Uu RLC channel ID(s) of the relay UE, and configure the remote UE with the identification information (e.g., NR cell global identifier (NCGI) and cell-radio network temporary identifier (C-RNTI)) of the relay UE. That is, the Uu PDCP entity of the remote UE is configured to associate with the Uu RLC entity of the relay UE. In other words, the Uu RLC entity of the relay UE is linked to its own PDCP entity (for its own traffic) along with the Uu PDCP entity of the remote UE. With such association, the remote UE may apply the PDCP entity to transmit or receive PDCP protocol data units (PDUs) over the non-3GPP connection, while the relay UE may apply the RLC entity to transmit or receive RLC service data units (SDUs) over the non-3GPP connection. Part (B) of FIG. 2 depicts a protocol stack mapping for MP relay using N3C indirect path, where the UE-to-UE link is provided with an association between the Uu PDCP entity in the remote UE and the Uu PDCP entity in the relay UE over a non-3GPP connection. The network (e.g., a gNB) may configure the relay UE with mapping(s) between the Uu RB ID(s) of the remote UE and the Uu RB ID(s) of the relay UE, and configure the remote UE with the identification information (e.g., NCGI and C-RNTI) of the relay UE.

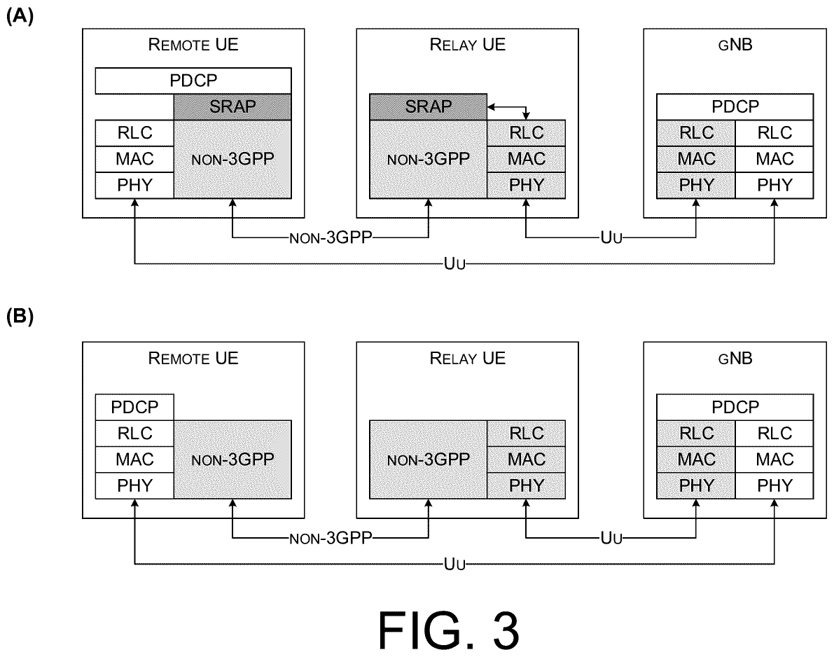

Referring to FIG. 3, Part (A) depicts a protocol stack mapping for MP relay using N3C indirect path, where the UE-to-UE link is provided with an association between the Uu PDCP entity in the remote UE and the Uu RLC entity in the relay UE over a non-3GPP connection, along with a sidelink relay adaptation protocol (SRAP) entity in each of the remote UE and the relay UE. That is, the SRAP entity takes the non-3GPP connection as an egress link. In one example, the SRAP header may include an RB ID of each PDCP PDU, and a UE ID. The RB ID may indicate the priority level (required QoS treatment) of the packet, and the UE ID may indicate who the packet belongs to. For instance, the relay UE may forward a packet if this packet has UE ID different from the relay UE's ID. Part (B) of FIG. 3 depicts a protocol stack mapping for MP relay using N3C indirect path, where the UE-to-UE link is provided with an association between the Uu RLC entity in the remote UE and the Uu RLC entity in the relay UE over a non-3GPP connection. That is, the non-3GPP connection is responsible for RLC SDU delivery. In the remote UE, downlink (DL) RLC SDU to be delivered to the PDCP entity can be from the Uu MAC entity in the remote UE or from the Uu RLC entity in the relay UE. The network (e.g., a gNB) may configure the relay UE with mapping(s) between the Uu RLC channel ID(s) of the remote UE and the Uu RLC channel ID(s) of the relay UE for specific RB(s).

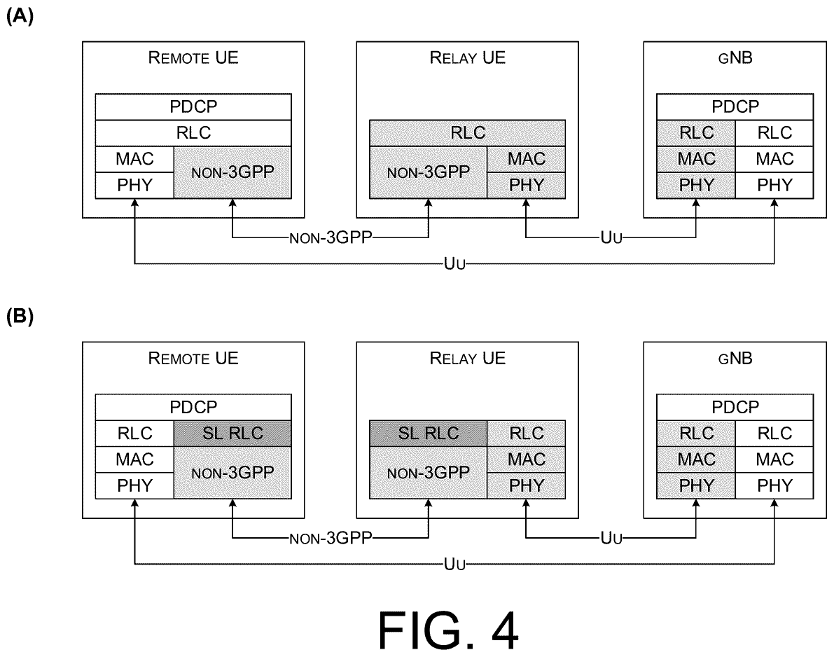

Referring to FIG. 4, Part (A) depicts a protocol stack mapping for MP relay using N3C indirect path, where the UE-to-UE link is provided with an association between the Uu RLC entity in the remote UE and the Uu RLC entity in the relay UE over a non-3GPP connection. The network (e.g., a gNB) may configure the relay UE with mapping(s) between the Uu RLC channel ID(s) of the remote UE and the Uu RLC channel ID(s) of the relay UE for specific RB(s). For both the remote UE and the relay UE, the Uu RLC entity is associated with both the Uu MAC entity and the non-3GPP radio access technology (RAT). For the non-3GPP connection, the delivered RLC PDU may include bearer mapping information, e.g., RB ID in the RLC PDU header. Part (B) of FIG. 4 depicts a protocol stack mapping for MP relay using N3C indirect path, where the UE-to-UE link is provided with an association between the sidelink (SL) RLC entity in the remote UE and the SL RLC entity in the relay UE over a non-3GPP connection. In particular, the SL RLC entity for the non-3GPP connection is not associated with the SL MAC entity or the SL PHY configuration. The network (e.g., a gNB) may configure the relay UE with mapping(s) between the Uu RLC channel ID(s) and the PC5 RLC channel ID(s) for specific RB(s), e.g., similar to SL-SRAP-Config-r17/SL-MappingToAddMod in 3GPP Release 17. Additionally, the network (e.g., a gNB) may configure the remote UE with mapping(s) between the Uu PDCP and SL RLC for specific RB(s), e.g., reuse the MP design for scenario 1 (using SL for UE-to-UE link) in 3GPP Release 18. Note that the SL RLC entity may be replaced with another entity capable of transmitting/receiving end-to-end RLC PDU between the remote UE and the relay UE (i.e., the SL RLC entity is different from Uu RLC entity).

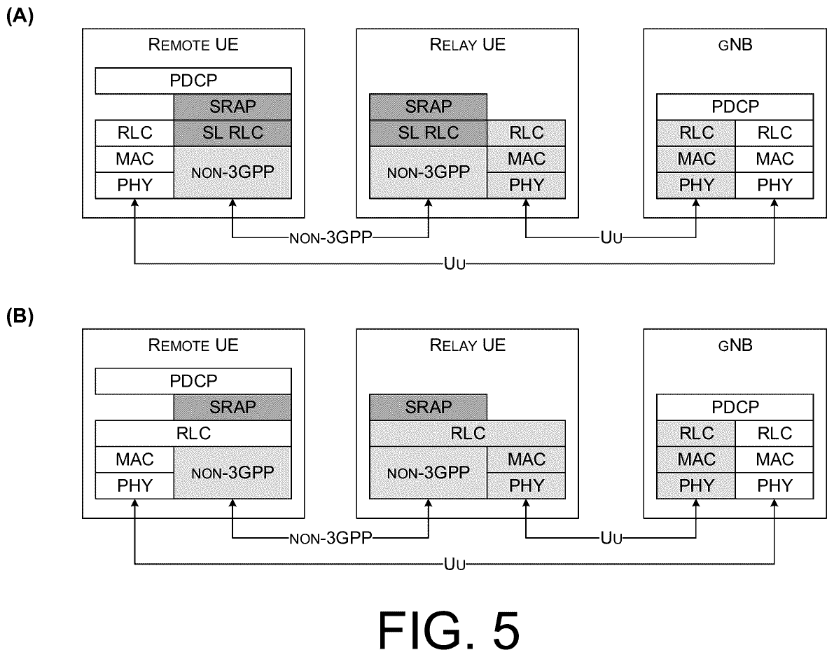

Referring to FIG. 5, Part (A) depicts a protocol stack similar to Part (B) of FIG. 4, expect that an SRAP entity is introduced in each of the remote UE and the relay UE to carry RB ID information. Part (B) of FIG. 5 depicts a protocol stack similar to Part (A) of FIG. 5, expect that the Uu RLC entity is also applied for RLC PDU/SDU transmission over the non-3GPP connection.

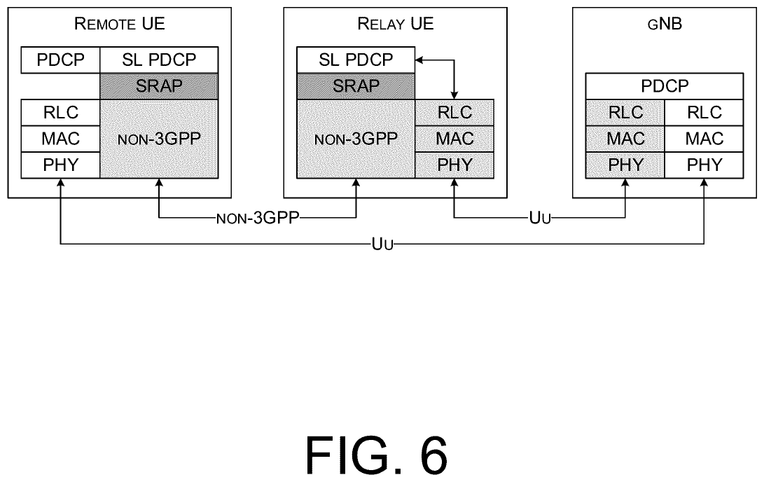

Referring to FIG. 6, a protocol stack mapping for MP relay using N3C indirect path is depicted, where an SL PDCP and an SRAP are introduced in each of the remote UE and the relay UE to deliver end-to-end PDCP PDU between the remote UE and the relay UE over the non-3GPP connection. In one example, the end-to-end PDCP PDU may be the payload of an SL PDCP PDU, and there's no need to introduce all functions of an SL PDCP entity. Note that the SL PDCP entity may be replaced with another entity capable of transmitting/receiving end-to-end PDCP PDU between the remote UE and the relay UE (i.e., the SL PDCP entity is different from Uu PDCP entity).

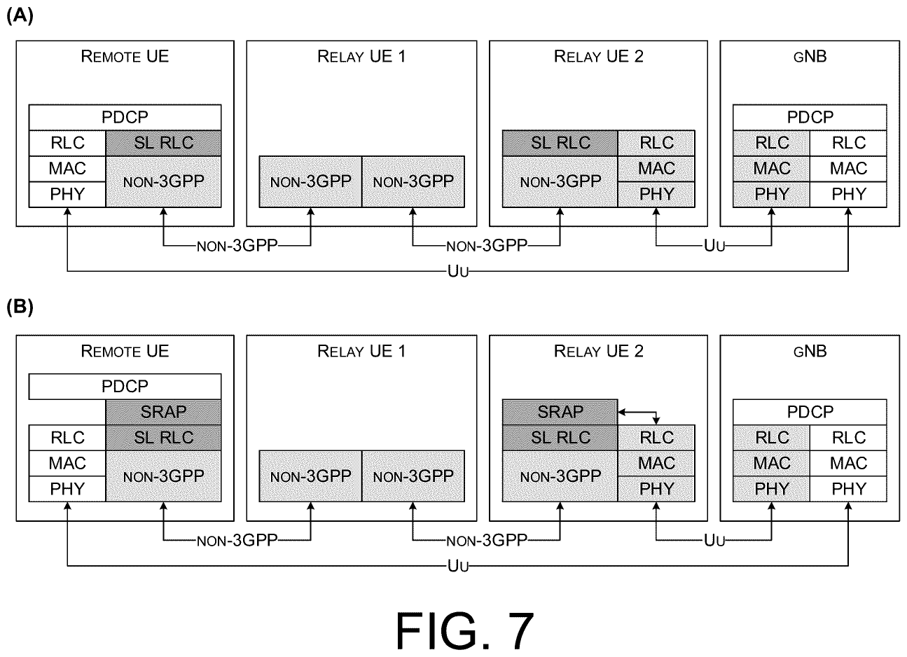

Referring to FIG. 7, Part (A) depicts a protocol stack mapping for multi-hop relay using N3C indirect path, where the UE-to-UE link between the remote UE and the relay UE 2 is provided with an association between the SL RLC entities in the remote UE and the relay UE 2 over the non-3GPP connections, including the non-3GPP connection between the remote UE and the relay UE 1 and the non-3GPP connection between the relay UEs. Part (B) of FIG. 7 depicts a protocol stack similar to Part (A) of FIG. 7, expect that an SRAP is introduced in each of the remote UE and the relay UE 2 to carry RB ID information.

In some implementations, the PDCP entity in the remote UE and/or the RLC entity in the relay UE at two ends of the non-3GPP connection may support functions of: (i) monitoring the non-3GPP connection, and (ii) receiving link failure notification from the non-3GPP connection. Specifically, to support monitoring of the non-3GPP connection, a timer and/or a transmission counter may be maintained for each delivered PDCP PDU or RLC SDU over the non-3GPP connection. For example, the timer expiry may trigger retransmission of the PDCP PDU or RLC SDU, and/or link failure may be detected when the number of retransmissions reaches a threshold or when transmission timeout occurs without response.

### Illustrative Implementations

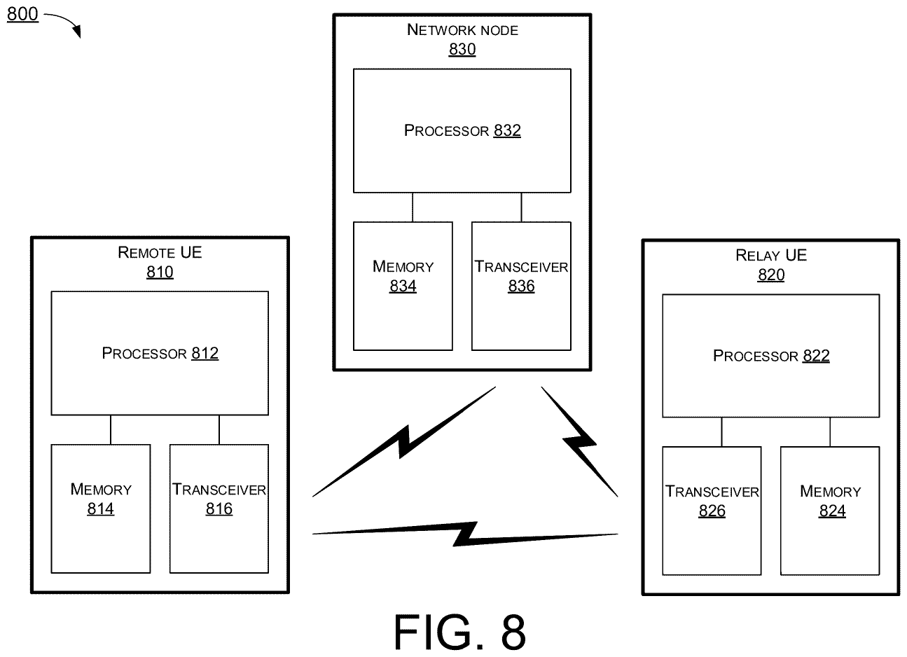

FIG. 8 illustrates an example communication system 800 having an example remote UE 810, an example relay UE 820, and an example network node 830 in accordance with an implementation of the present disclosure. Each of remote UE 810, relay UE 820, and network node 830 may perform various functions to implement schemes, techniques, processes and methods described herein pertaining to supporting UE aggregation with non-3GPP connection in mobile communications, including scenarios/schemes described above as well as processes 900, 1000, and 1100 described below.

Remote UE 810 may be a part of an electronic apparatus such as a portable or mobile apparatus, a wearable apparatus, a wireless communication apparatus or a computing apparatus. For instance, remote UE 810 may be implemented in a smartphone, a smartwatch, a personal digital assistant, a digital camera, or a computing equipment such as a tablet computer, a laptop computer or a notebook computer. Remote UE 810 may also be a part of a machine type apparatus, which may be an IoT, NB-IoT, or IIoT apparatus such as an immobile or a stationary apparatus, a home apparatus, a wire communication apparatus or a computing apparatus. For instance, remote UE 810 may be implemented in a smart thermostat, a smart fridge, a smart door lock, a wireless speaker or a home control center. Alternatively, remote UE 810 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Remote UE 810 may include at least some of those components shown in FIG. 8 such as a processor 812, for example. Remote UE 810 may further include one or more other components not pertinent to the proposed scheme of the present disclosure (e.g., internal power supply, display device and/or user interface device), and, thus, such component(s) of remote UE 810 are neither shown in FIG. 8 nor described below in the interest of simplicity and brevity.

Relay UE 820 may be a part of an electronic apparatus such as a portable or mobile apparatus, a wearable apparatus, a wireless communication apparatus or a computing apparatus. For instance, relay UE 820 may be implemented in a customer premise equipment (CPE), a smartphone, a smartwatch, a personal digital assistant, a digital camera, or a computing equipment such as a tablet computer, a laptop computer or a notebook computer. Relay UE 820 may also be a part of a machine type apparatus, which may be an IoT, NB-IoT, or IIoT apparatus such as an immobile or a stationary apparatus, a home apparatus, a wire communication apparatus or a computing apparatus. For instance, relay UE 820 may be implemented in a smart thermostat, a smart fridge, a smart door lock, a wireless speaker or a home control center. Alternatively, relay UE 820 may be implemented in the form of one or more IC chips such as, for example and without limitation, one or more single-core processors, one or more multi-core processors, one or more RISC processors, or one or more CISC processors. Relay UE 820 may include at least some of those components shown in FIG. 8 such as a processor 822, for example. Relay UE 820 may further include one or more other components not pertinent to the proposed scheme of the present disclosure (e.g., internal power supply, display device and/or user interface device), and, thus, such component(s) of relay UE 820 are neither shown in FIG. 8 nor described below in the interest of simplicity and brevity.

Network node 830 may be a part of an electronic apparatus, which may be a BS, a satellite, a small cell, a router or a gateway. For instance, network node 830 may be implemented in a satellite or an eNB/gNB/TRP in a 4G/5G, NR, IoT, NB-IoT or IIoT network. Alternatively, network node 830 may be implemented in the form of one or more IC chips such as, for example and without limitation, one or more single-core processors, one or more multi-core processors, or one or more RISC or CISC processors. Network node 830 may include at least some of those components shown in FIG. 8 such as a processor 832, for example. Network node 830 may further include one or more other components not pertinent to the proposed scheme of the present disclosure (e.g., internal power supply, display device and/or user interface device), and, thus, such component(s) of network node 830 are neither shown in FIG. 8 nor described below in the interest of simplicity and brevity.

In one aspect, each of processor 812, processor 822, and processor 832 may be implemented in the form of one or more single-core processors, one or more multi-core processors, or one or more CISC processors. That is, even though a singular term “a processor” is used herein to refer to processor 812, processor 822, and processor 832, each of processor 812, processor 822, and processor 832 may include multiple processors in some implementations and a single processor in other implementations in accordance with the present disclosure. In another aspect, each of processor 812, processor 822, and processor 832 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 812, processor 822, and processor 832 is a special-purpose machine specifically designed, arranged and configured to perform specific tasks including supporting UE aggregation with non-3GPP connection in a UE (e.g., remote UE 810 or relay UE 820) or in a network node (e.g., network node 830) in accordance with various implementations of the present disclosure.

In some implementations, remote UE 810 may also include a transceiver 816 coupled to processor 812 and capable of wirelessly transmitting and receiving data. In some implementations, transceiver 816 may be capable of wirelessly communicating with other UEs and/or network nodes of different RATs, including 3GPP RATs (e.g., LTE, 5G NR, IoT/NB-IoT/IIoT, B5G, and 6G) and non-3GPP RATs (e.g., Wi-Fi and BT). In some implementations, transceiver 816 may be equipped with multiple transmit antennas and multiple receive antennas for multiple-input multiple-output (MIMO) wireless communications. In some implementations, relay UE 820 may also include a transceiver 826 coupled to processor 822 and capable of wirelessly transmitting and receiving data. In some implementations, transceiver 826 may be capable of wirelessly communicating with other UEs or network nodes of different RATs, including 3GPP RATs (e.g., LTE, 5G NR, IoT/NB-IoT/IIoT, B5G, and 6G) and non-3GPP RATs (e.g., Wi-Fi and BT). In some implementations, transceiver 826 may be equipped with multiple transmit antennas and multiple receive antennas for MIMO wireless communications. In some implementations, network node 830 may also include a transceiver 836 coupled to processor 832 and capable of wirelessly transmitting and receiving data. In some implementations, transceiver 836 may be capable of wirelessly communicating with UEs using different RATs, e.g., 3GPP RATs (e.g., LTE, 5G NR, IoT/NB-IoT/IIoT, B5G, and 6G). In some implementations, transceiver 836 may be equipped with multiple transmit antennas and multiple receive antennas for MIMO wireless communications.

In some implementations, remote UE 810 may further include a memory 814 coupled to processor 812 and capable of being accessed by processor 812 and storing data therein. In some implementations, relay UE 820 may further include a memory 824 coupled to processor 822 and capable of being accessed by processor 822 and storing data therein. In some implementations, network node 830 may further include a memory 834 coupled to processor 832 and capable of being accessed by processor 832 and storing data therein. Each of memory 814, memory 824, and memory 834 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 814, memory 824, and memory 834 may include a type of read-only memory (ROM) such as mask ROM, programmable ROM (PROM), erasable programmable ROM (EPROM) and/or electrically erasable programmable ROM (EEPROM). Alternatively, or additionally, each of memory 814, memory 824, and memory 834 may include a type of non-volatile random-access memory (NVRAM) such as flash memory, solid-state memory, ferroelectric RAM (FeRAM), magnetoresistive RAM (MRAM) and/or phase-change memory.

Under certain proposed schemes in accordance with the present disclosure with respect to supporting UE aggregation with non-3GPP connection from remote UE's perspective, processor 812 may connect, via transceiver 816, to relay UE 820 using a non-3GPP connection. Then, processor 812 may receive, via transceiver 826, an RRC message from network node 830, wherein the RRC message may include a configuration of an N3C indirect path between remote UE 810 and network node 830 through relay UE 820. Also, processor 812 may perform, via transceiver 816, one or more first data transmissions or receptions on the N3C indirect path according to the configuration, wherein the first data transmissions or receptions on the N3C indirect path are performed with an association between a first protocol entity in the remote UE and a second protocol entity in the relay UE over the non-3GPP connection.

In some implementations, the first protocol entity may include a PDCP entity and the second protocol entity may include an RLC entity.

In some implementations, the PDCP entity may include a Uu PDCP entity, and the RLC entity may include a Uu RLC entity.

In some implementations, the performing of the first data transmissions or receptions on the N3C indirect path may include applying the PDCP entity to transmit or receive one or more PDCP PDUs over the non-3GPP connection.

In some implementations, processor 812 may also connect, via transceiver 816, to network node 830 on a direct path using a 3GPP radio interface. Additionally, processor 812 may perform, via transceiver 816, one or more second data transmissions or receptions on the direct path.

In some implementations, the 3GPP radio interface may include a Uu interface.

In some implementations, the RRC message may include an RRC reconfiguration message.

Under certain proposed schemes in accordance with the present disclosure with respect to supporting UE aggregation with non-3GPP connection from relay UE's perspective, processor 822 may connect, via transceiver 826, with remote UE 810 using a non-3GPP connection. Then, processor 822 may receive, via transceiver 826, an RRC message from network node 830, wherein the RRC message may include a configuration of an N3C indirect path between remote UE 810 and network node 830 through relay UE 820. Also, processor 822 may forward, via transceiver 826, data traffic on the N3C indirect path according to the configuration, wherein the forwarding of the data traffic on the N3C indirect path is performed with an association between a first protocol entity in the remote UE and a second protocol entity in the relay UE over the non-3GPP connection.

In some implementations, the first protocol entity may include a PDCP entity and the second protocol entity may include an RLC entity.

In some implementations, the PDCP entity may include a Uu PDCP entity, and the RLC entity may include a Uu RLC entity.

In some implementations, the forwarding of the data traffic on the N3C indirect path may include processor 822 applying the RLC entity to transmit or receive one or more RLC SDUs over the non-3GPP connection.

In some implementations, the configuration may include at least one mapping between an RB ID of the remote UE and an RLC channel ID of the relay UE.

In some implementations, processor 822 may also associate the RB ID of the remote UE with the RLC channel ID of the relay UE.

In some implementations, the RRC message may include an RRC reconfiguration message.

Under certain proposed schemes in accordance with the present disclosure with respect to supporting UE aggregation with non-3GPP connection from network's perspective, processor 832 may transmit, via transceiver 836, an RRC message to remote UE 810 and relay UE 820, wherein the RRC message may include a configuration of an N3C indirect path between remote UE 810 and network node 830 through relay UE 820. Then, processor 832 may perform, via transceiver 836, one or more first data transmissions or receptions on the N3C indirect path according to the configuration, wherein the first data transmissions or receptions on the N3C indirect path are performed with an association between a first protocol entity in the remote UE and a second protocol entity in the relay UE over the non-3GPP connection.

In some implementations, the first protocol entity may include a PDCP entity and the second protocol entity may include an RLC entity.

In some implementations, the PDCP entity may include a Uu PDCP entity, and the RLC entity may include a Uu RLC entity.

In some implementations, the configuration may include at least one mapping between an RB ID of the remote UE and an RLC channel ID of the relay UE.

In some implementations, processor 832 may also connect, via transceiver 836, with remote UE 810 on a direct path using a 3GPP radio interface. Additionally, processor 832 may perform, via transceiver 836, one or more second data transmissions or receptions on the direct path.

In some implementations, the RRC message may include an RRC reconfiguration message.

### Illustrative Processes

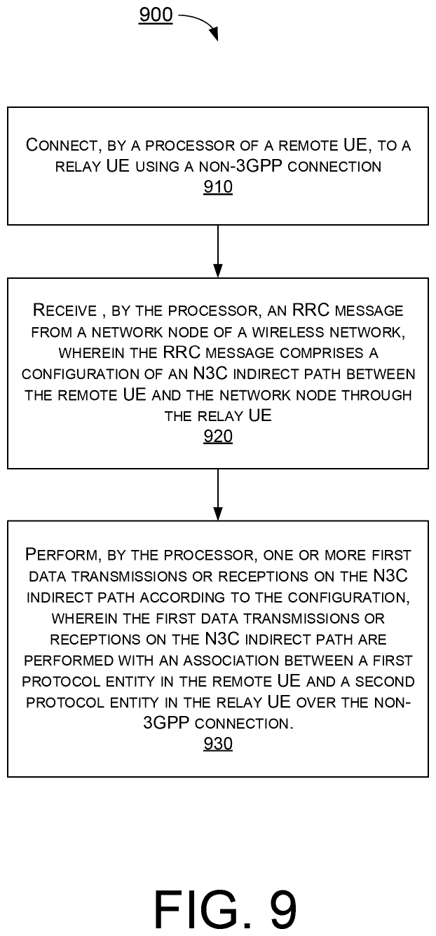

FIG. 9 illustrates an example process 900 in accordance with an implementation of the present disclosure. Process 900 may be an example implementation of above scenarios/schemes, whether partially or completely, with respect to supporting UE aggregation with non-3GPP connection in mobile communications. Process 900 may represent an aspect of implementation of features of remote UE 810. Process 900 may include one or more operations, actions, or functions as illustrated by one or more of blocks 910 to 930. Although illustrated as discrete blocks, various blocks of process 900 may be divided into additional blocks, combined into fewer blocks, or eliminated, depending on the desired implementation. Moreover, the blocks of process 900 may be executed in the order shown in FIG. 9 or, alternatively, in a different order. Process 900 may be implemented by remote UE 810 or any suitable UE or machine type devices. Solely for illustrative purposes and without limitation, process 900 is described below in the context of remote UE 810. Process 900 may begin at block 910.

At 910, process 900 may involve processor 812 of remote UE 810 connecting, via transceiver 816, to a relay UE (e.g., relay UE 820) using a non-3GPP connection. Process 900 may proceed from 910 to 920.

At 920, process 900 may involve processor 812 receiving, via transceiver 816, an RRC message from a network node (e.g., network node 830) of a wireless network, wherein the RRC message comprises a configuration of an N3C indirect path between remote UE 810 and the network node through the relay UE. Process 900 may proceed from 920 to 930.

At 930, process 900 may involve processor 812 performing, via transceiver 826, one or more first data transmissions or receptions on the N3C indirect path according to the configuration, wherein the first data transmissions or receptions on the N3C indirect path are performed with an association between a first protocol entity in the remote UE and a second protocol entity in the relay UE over the non-3GPP connection.

In some implementations, the first protocol entity may include a PDCP entity and the second protocol entity may include an RLC entity.

In some implementations, the PDCP entity may include a Uu PDCP entity, and the RLC entity may include a Uu RLC entity.

In some implementations, the performing of the first data transmissions or receptions on the N3C indirect path may include applying the PDCP entity to transmit or receive one or more PDCP PDUs over the non-3GPP connection.

In some implementations, process 900 may further involve processor 812 connecting, via transceiver 816, to the network node on a direct path using a 3GPP radio interface. Additionally, process 900 may also involve processor 812 performing, via transceiver 816, one or more second data transmissions or receptions on the direct path.

In some implementations, the 3GPP radio interface may include a Uu interface.

In some implementations, the RRC message may include an RRC reconfiguration message.

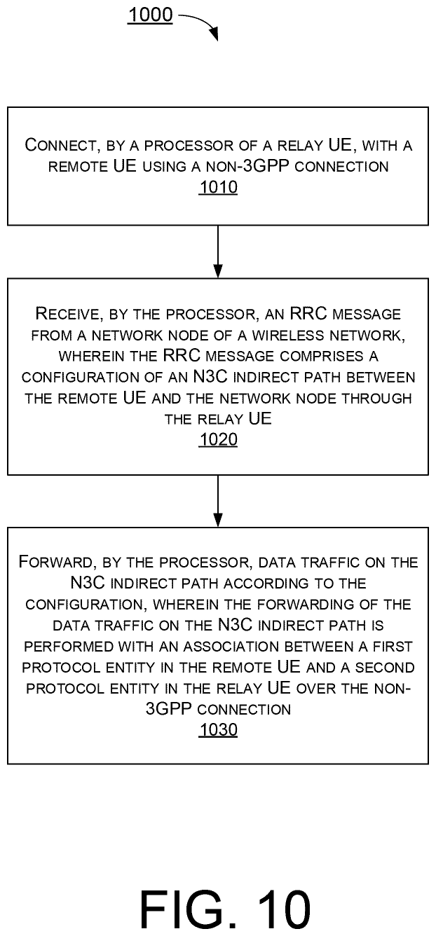

FIG. 10 illustrates an example process 1000 in accordance with an implementation of the present disclosure. Process 1000 may be an example implementation of above scenarios/schemes, whether partially or completely, with respect to supporting UE aggregation with non-3GPP connection in mobile communications. Process 1000 may represent an aspect of implementation of features of relay UE 820. Process 1000 may include one or more operations, actions, or functions as illustrated by one or more of blocks 1010 to 1030. Although illustrated as discrete blocks, various blocks of process 1000 may be divided into additional blocks, combined into fewer blocks, or eliminated, depending on the desired implementation. Process 1000 may be implemented by relay UE 820 or any suitable UE or machine type devices. Solely for illustrative purposes and without limitation, process 1000 is described below in the context of relay UE 820.

At 1010, process 1000 may involve processor 822 of relay UE 820 connecting, via transceiver 826, with a remote UE (e.g., remote UE 810) using a non-3GPP connection. Process 1000 may proceed from 1010 to 1020.

At 1020, process 1000 may involve processor 822 receiving, via transceiver 826, an RRC message from a network node (e.g., network node 830) of a wireless network, wherein the RRC message comprises a configuration of an N3C indirect path between the remote UE and the network node through relay UE 820. Process 1000 may proceed from 1020 to 1030.

At 1030, process 1000 may involve processor 822 forwarding, via transceiver 826, data traffic on the N3C indirect path according to the configuration, wherein the forwarding of the data traffic on the N3C indirect path is performed with an association between a first protocol entity in the remote UE and a second protocol entity in the relay UE over the non-3GPP connection.

In some implementations, the first protocol entity may include a PDCP entity and the second protocol entity may include an RLC entity.

In some implementations, the PDCP entity may include a Uu PDCP entity, and the RLC entity may include a Uu RLC entity.

In some implementations, the forwarding of the data traffic on the N3C indirect path may include applying the RLC entity to transmit or receive one or more RLC SDUs over the non-3GPP connection.

In some implementations, the configuration may include at least one mapping between an RB ID of the remote UE and an RLC channel ID of the relay UE.

In some implementations, process 1000 may further involve processor 822 associating the RB ID of the remote UE with the RLC channel ID of the relay UE.

In some implementations, the RRC message may include an RRC reconfiguration message.

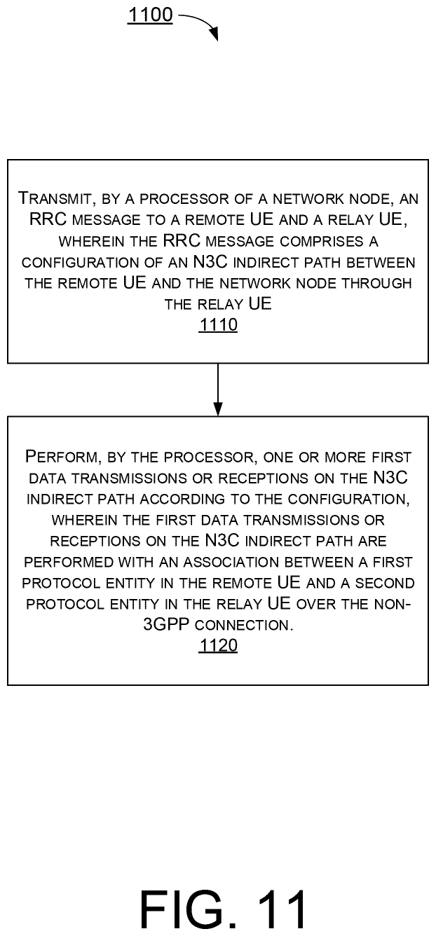

FIG. 11 illustrates an example process 1100 in accordance with an implementation of the present disclosure. Process 1100 may be an example implementation of above scenarios/schemes, whether partially or completely, with respect to supporting UE aggregation with non-3GPP connection in mobile communications. Process 1100 may represent an aspect of implementation of features of network node 830. Process 1100 may include one or more operations, actions, or functions as illustrated by one or more of blocks 1110 and 1120. Although illustrated as discrete blocks, various blocks of process 1100 may be divided into additional blocks, combined into fewer blocks, or eliminated, depending on the desired implementation. Process 1100 may be implemented by network node 830 or any suitable network apparatus (e.g., a BS such as an eNB/gNB/TRP in a 4G LTE or 5G NR network). Solely for illustrative purposes and without limitation, process 1100 is described below in the context of network node 830.

At 1110, process 1100 may involve processor 832 of network node 830 transmitting, via transceiver 836, an RRC message to a remote UE (e.g., remote UE 810) and a relay UE (e.g., relay UE 820), wherein the RRC message comprises a configuration of an N3C indirect path between the remote UE and the network node through the relay UE. Process 1100 may proceed from 1110 to 1120.

At 1120, process 1100 may involve processor 832 performing, via transceiver 836, one or more first data transmissions or receptions on the N3C indirect path according to the configuration, wherein the first data transmissions or receptions on the N3C indirect path are performed with an association between a first protocol entity in the remote UE and a second protocol entity in the relay UE over the non-3GPP connection.

In some implementations, the first protocol entity may include a PDCP entity and the second protocol entity may include an RLC entity.

In some implementations, the PDCP entity may include a Uu PDCP entity, and the RLC entity may include a Uu RLC entity.

In some implementations, the configuration may include at least one mapping between an RB ID of the remote UE and an RLC channel ID of the relay UE.

In some implementations, process 1100 may further involve processor 832 connecting, via transceiver 836, with the remote UE on a direct path using a 3GPP radio interface. Additionally, process 1100 may also involve processor 832 performing, via transceiver 836, one or more second data transmissions or receptions on the direct path.

In some implementations, the RRC message may include an RRC reconfiguration message.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
connecting, by a processor of a remote user equipment (UE), to a relay UE using a non-3^{rd} generation partnership project (3GPP) connection;
receiving, by the processor, a radio resource control (RRC) message from a network node of a wireless network, wherein the RRC message comprises a configuration of a non-3GPP connection (N3C) indirect path between the remote UE and the network node through the relay UE;
performing, by the processor, one or more first data transmissions or receptions on the N3C indirect path according to the configuration, wherein the first data transmissions or receptions on the N3C indirect path are performed with an association between a first protocol entity in the remote UE and a second protocol entity in the relay UE over the non-3GPP connection.

2. The method of claim 1, wherein the first protocol entity comprises a packet data convergence protocol (PDCP) entity and the second protocol entity comprises a radio link control (RLC) entity.

3. The method of claim 2, wherein the PDCP entity comprises a Uu PDCP entity, and the RLC entity comprises a Uu RLC entity.

4. The method of claim 2, wherein the performing of the first data transmissions or receptions on the N3C indirect path comprises:
applying the PDCP entity to transmit or receive one or more PDCP protocol data units (PDUs) over the non-3GPP connection.

5. The method of claim 1, further comprising:
connecting, by the processor, to the network node on a direct path using a 3GPP radio interface; and
performing, by the processor, one or more second data transmissions or receptions on the direct path.

6. The method of claim 1, wherein the 3GPP radio interface comprises a Uu interface.

7. The method of claim 1, wherein the RRC message comprises an RRC reconfiguration message.

8. A method, comprising:
connecting, by a processor of a relay user equipment (UE), with a remote UE using a non-3^{rd} generation partnership project (3GPP) connection;
receiving, by the processor, a radio resource control (RRC) message from a network node of a wireless network, wherein the RRC message comprises a configuration of a non-3GPP connection (N3C) indirect path between the remote UE and the network node through the relay UE;
forwarding, by the processor, data traffic on the N3C indirect path according to the configuration, wherein the forwarding of the data traffic on the N3C indirect path is performed with an association between a first protocol entity in the remote UE and a second protocol entity in the relay UE over the non-3GPP connection.

9. The method of claim 8, wherein the first protocol entity comprises a packet data convergence protocol (PDCP) entity and the second protocol entity comprises a radio link control (RLC) entity.

10. The method of claim 9, wherein the PDCP entity comprises a Uu PDCP entity, and the RLC entity comprises a Uu RLC entity.

11. The method of claim 9, wherein the forwarding of the data traffic on the N3C indirect path comprises:
applying the RLC entity to transmit or receive one or more RLC service data units (SDUs) over the non-3GPP connection.

12. The method of claim 8, wherein the configuration comprises at least one mapping between a radio bearer (RB) identity (ID) of the remote UE and an RLC channel ID of the relay UE.

13. The method of claim 12, further comprising:
associating, by the processor, the RB ID of the remote UE with the RLC channel ID of the relay UE.

14. The method of claim 8, wherein the RRC message comprises an RRC reconfiguration message.

15. A method, comprising:
transmitting, by a processor of a network node, a radio resource control (RRC) message to a remote user equipment (UE) and a relay UE, wherein the RRC message comprises a configuration of a non-3GPP connection (N3C) indirect path between the remote UE and the network node through the relay UE; and
performing, by the processor, one or more first data transmissions or receptions on the N3C indirect path according to the configuration, wherein the first data transmissions or receptions on the N3C indirect path are performed with an association between a first protocol entity in the remote UE and a second protocol entity in the relay UE over the non-3GPP connection.

16. The method of claim 15, wherein the first protocol entity comprises a packet data convergence protocol (PDCP) entity and the first protocol entity comprises a radio link control (RLC) entity.

17. The method of claim 16, wherein the PDCP entity comprises a Uu PDCP entity, and the RLC entity comprises a Uu RLC entity.

18. The method of claim 15, wherein the configuration comprises at least one mapping between a radio bearer (RB) identity (ID) of the remote UE and an RLC channel ID of the relay UE.

19. The method of claim 15, further comprising:
connecting, by the processor, with the remote UE on a direct path using a 3GPP radio interface; and
performing, by the processor, one or more second data transmissions or receptions on the direct path.

20. The method of claim 15, wherein the RRC message comprises an RRC reconfiguration message.
